(19) United States
(12) Patent Application Publication
(10) Pub. No.: US 2016/0288690 A1
(43) Pub. Date: Oct. 6, 2016

(54) Slide-Out Extension for a Caravan

(71) Applicant: Glenn Stuart Wills, Milton, Queensland (AU)

(72) Inventor: Glenn Stuart Wills, Milton, Queensland (AU)

(21) Appl. No.: 15/036,886

(22) PCT Filed: Nov. 13, 2014
(86) PCT No.: PCT/AU2014/050348

§ 371 Date: May 16, 2016

(30) Foreign Application Priority Data
Nov. 18, 2013 (AU) 2013904447
Dec. 23, 2013 (AU) 2013905034

(51) Int. Cl. B60P 3/34

(52) U.S. Cl. CPC B60P 3/34

(57) ABSTRACT

A caravan including: a chassis including wheels and a drawbar extending away from the wheels; a tow hitch mounted at a terminal end of the drawbar; a hollow body supported by the chassis, the body defining an internal volume and including an opening in a leading end of the body facing the tow hitch; and a slide-out extension mounted in the opening, the slide-out extension being slidingly moveable relative to the body between a closed position in which the slide-out extension is received within the body and closes the opening, and an open position in which the slide-out extension extends from the opening towards the tow hitch to thereby expand the internal volume of the body, the slide-out extension being at least partially supported by the drawbar when in the open position.

### BACKGROUND OF THE INVENTION

The present invention relates to a slide-out extension for a caravan and a folding bed for use with such a slide-out extension. The present invention is especially, but not exclusively, suitable for a teardrop camper style of caravan.

### Description of the Prior Art

It is known to provide expandable caravans which can be reconfigured between a compact configuration for towing and an expanded configuration which provides a greater internal volume for use by occupants. Some examples of expandable caravans include an expandable roof compartment that can be lowered for towing and raised to expand the internal volume upwardly and allow occupants to stand inside the caravan.

In other examples of expandable caravans, these may include slide-out compartments that can be extended from a side or rear wall of the caravan to expand the internal volume outwardly. However, the amount of expansion achievable by outward slide-out compartments is limited due to the fact that these are generally cantilevered from the caravan body, such that long extension lengths will typically not be feasible. As a result, most conventional expandable caravans only provide for relatively short extension lengths which are not suitable for extending the bed area of the caravan and instead seek to expand living or kitchen areas from side walls of the caravan.

Teardrop campers evolved in the USA in the 1930's and became extremely popular in the late 1940's after World War II. The teardrop campers were light weight and could easily be pulled behind the family cars which in those days were under 100 horsepower

This popularity of the teardrop campers continued through the 1950's due to the do-it-yourselfers making their own teardrop campers and most using the plans published in “Popular Mechanics” magazine using cheap materials from World War II surplus markets. The late 1950's bought the demise of the teardrop camper with more powerful cars, cheap fuel and people wanting bigger campers and caravans.

A lot has changed since the introduction of the teardrop camper and now they have become popular again due to smaller cars, higher fuel prices and the environment. With most of our populations now living in cities and urban spaces getting smaller, most inhabitants only have access to two standard car spaces so the teardrop camper is perfect for this situation. The general problem is people now like to carry more things; appliances, clothes, toiletries and all the electronic gadgets of today but it is very difficult to fit all these items into a small teardrop camper. When in the sleeping position in most teardrop campers the occupants' feet are up under the kitchen bench which then means there is little space for kitchen storage at the rear or wardrobe space in the sleeping area. The teardrop campers could also be very claustrophobic trying to fit as much as possible into such a small space.

It would therefore be desirable to be able to extend out the bed area of a caravan, such as a teardrop camper, without taking any space from the wardrobe and kitchen area.

As we all battle higher fuel prices and the environment there is an increasing movement to smaller and lighter cars but people still want their travelling holidays towing the caravan behind. This has bought about the resurgence of the compact teardrop camper but of course there is not a lot that you can fit into a teardrop camper compared to the larger caravans. Another problem is there is nowhere to sit inside if it is raining or cold and it's difficult lying on the bed trying to eat Or you might need a desk to work at if you are travelling and need to be working on your computer or checking emails and it is too bright outside or you need a comfortable working position.

It would therefore be desirable to be able to convert the bed area of a caravan, such as a teardrop camper, to provide a lounge.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in, the field of endeavour to which this specification relates.

### SUMMARY OF THE PRESENT INVENTION

In a broad form the present invention seeks to provide a caravan including:
a) a chassis including wheels and a drawbar extending away from the wheels;
b) a tow hitch mounted at a terminal end of the drawbar;
c) a hollow body supported by the chassis, the body defining an internal volume and including an opening in a leading end of the body facing the tow hitch; and,
d) a slide-out extension mounted in the opening, the slide-out extension being slidingly moveable relative to the body between a closed position in which the slide-out extension is received within the body and closes the opening, and an open position in which the slide-out extension extends from the opening towards the tow hitch to thereby expand the internal volume of the body, the slide-out extension being at least partially supported by the drawbar when in the open position.

Typically, when the slide-out extension is in the open position, a portion of the slide-out extension rests upon the drawbar so that the slide-out extension is least partially supported by the drawbar.

Typically the slide-out extension is configured to slide along the drawbar as the slide-out extension is moved between the closed position and the open position.

Typically the slide-out extension includes skid pads for allowing the slide-out extension to slide along the drawbar on the skid pads, the slide-out extension being at least partially supported by the drawbar via the skid pads

Typically the slide-out extension further includes slide rails mounted to one of the body and the chassis, the slide-out extension, being partially supported by the slide rails as the slide-out extension is moved between the closed position and the open position.

Typically the body includes a caravan tail at a trailing end of the body opposing the leading end, a caravan floor, a caravan roof and opposing caravan side walls, and the slide-out extension includes a slide-out nose, a slide-out floor, a slide-out roof and opposing slide-out side walls, wherein the slide-out nose closes the opening when the slide-out extension is in the closed position

Typically the slide-out extension is in the closed position, the slide-out roof, floor and side walls are located inside of the caravan roof, floor and side-walls

Typically the slide-out nose includes outer edges which overlap respective perimeter edges of the opening when the slide-out extension is in the closed position.

Typically the slide-out extension includes a slide-out sealing strip along at least one of the outer edges of the slide-out nose for engaging with a respective perimeter edge of the opening to form a seal when the slide-out extension is in the closed position.

Typically the body includes an outer body sealing strip along an outside surface of at least one perimeter edge of the opening for engaging with an inside surface of the slide-out nose to form a seal when the slide-out extension is in the closed position,

Typically the body includes an inner body sealing strip along an inside surface of at least one perimeter edge of the opening for engaging with a ridge along a trailing edge of at least one of the slide-out floor, roof and side walls to form a seal when the slide-out extension is in the open position.

Typically the body includes a gutter extending along an upper perimeter edge of the opening adjacent to the caravan roof

Typically the body includes drains extending along side perimeter edges of the opening adjacent to the caravan side walls.

Typically the slide-out roof includes a convex upper surface

Typically the caravan includes a locking pin for locking the slide-out extension relative to the body to thereby prevent movement.

Typically the caravan includes a folding bed that is reconfigurable between a folded configuration when the slide-out extension is in the closed position and a flat configuration when the slide-out extension is in the open position

Typically the folding bed includes a plurality of panels for supporting mattress sections, at least one of the panels being hinged for allowing at least a portion of the folding bed to be folded inside the internal volume of the body when the slide-out extension is in the closed position.

Typically at least one of the panels provides a floor portion of the slide-out extension when the slide-out extension is in the open position

Typically the folding bed includes two hingedly connected panels that fold together in a raised arrangement when the slide-out extension is in the closed position and the folding bed is in the folded configuration.

Typically the folding bed is further reconfigurable from the flat configuration into a lounge configuration when the slide-out extension is in the open position.

Typically the folding bed includes a plurality of hingedly connected panels including an end panel that is moveable between a first position for providing an end of the folding bed in the flat configuration and a second position for providing a lounge seat in the lounge configuration, at least two other panels folding together in a raised arrangement for providing a lounge back.

Typically the folding bed includes an end panel mounted on brackets that are pivoted relative to the body so that the end panel that is moveable between a first position for providing an end of the folding bed in the flat configuration and a second position for providing a lounge back in the lounge configuration.

Typically moving the end panel away from the first position exposes a recessed floor area for receiving feet of a user of the folding bed in the lounge configuration.

Typically the caravan is in the form of a teardrop camper.

Typically the slide-out extension includes a curved nose section of the teardrop cam per.

In another broad form the present invention seeks to provide a teardrop camper including a lightweight slide-out compartment that is mounted in the teardrop camper with an automatic internal fold out floor and mattress using a subframe drawbar and sliding runners to support the slide-out compartment whilst sliding smoothly on runners in the motion of opening and closing to allow the internal space of the teardrop camper to almost double.

In another broad form the present invention seeks to provide a teardrop camper having a slide-out compartment including several sections of flooring, hinges and brackets not fixed to a steel section floor frame but floating, which can be positioned in such a way as to when the slide-out compartment is extended the sections of flooring become a lounge using mattress sections as cushioning but can be easily unfolded flat again to become a bed or when transporting folds up into a fixed position.

### BRIEF DESCRIPTION OF THE DRAWINGS

An example of the present invention will now be described with reference to the accompanying drawings, in which:

FIG. 1 is a side view of an example of a caravan including a slide-out extension in a closed position;

FIG. 2 is a side view of the caravan of FIG. 1, with the slide-out extension in an open position,

FIG. 3 is cross section view of a forward portion of the caravan of FIG. 1, with the slide-out extension in the open position;

FIG. 4 is a top view of the forward portion of the caravan of FIG. 1, with the slide-out extension in the open position;

FIG. 5 is a cross section detail view of a seal arrangement of the caravan of FIG. 1, with the slide-out extension in the closed position;

FIG. 6 is a cross section detail view of a seal arrangement of the caravan of FIG. 1, with the slide-out extension in the open position;

FIG. 7 is a cross section view of the caravan of FIG. 1, with the slide-out extension in the open position, including a first embodiment of a folding bed;

FIG. 8 is another cross section view of the caravan and folding bed of FIG. 7, with the slide-out extension moving towards the closed position;

FIG. 9 is a cross section view of the caravan of FIG. 1, with the slide-o extension in the closed position, and including a second embodiment of a folding bed;

FIG. 10 is another cross section view of the caravan and the folding bed of FIG. 9, with the slide-out extension in the open position and the folding bed in a flat configuration,

FIG. 11 is another cross section view of the caravan and folding furniture arrangement of FIG. 9, with the slide-out extension in the open position and the folding bed in a lounge configuration,

FIG. 12 is a cross section view of the caravan of FIG. 1, with the slide-out extension in the closed position, and including a third embodiment of a folding bed,

FIG. 13 is another cross section view of the caravan and folding furniture arrangement of FIG. 12, with the slide-out extension in the open position and the folding bed in a lounge configuration;

FIG. 14 is a cross section view of the caravan of FIG. 1, with the slide-out extension in the closed position, and including a fourth embodiment of a folding furniture arrangement; and,

FIG. 15 is another cross section view of the caravan and folding furniture arrangement of FIG. 14, with the slide-out extension in the open position and the folding bed in a lounge configuration.

### DETAILED DESCRIPTION OF THE PREFERRED EMBODIMENTS

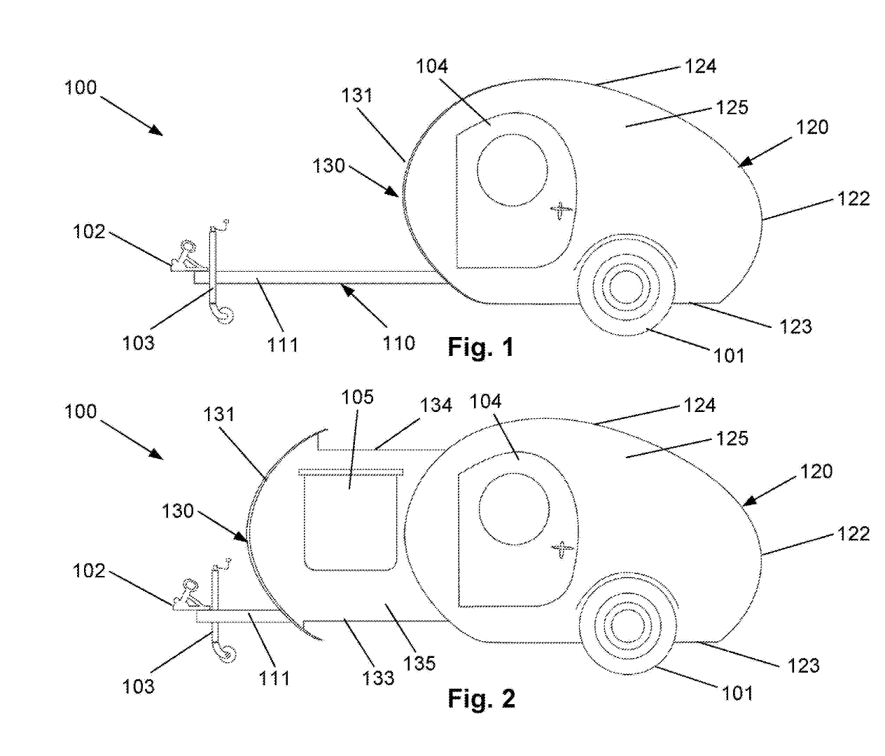

An example of a caravan 100 including a slide-out extension will now be described with reference to FIGS. 1 to 8,

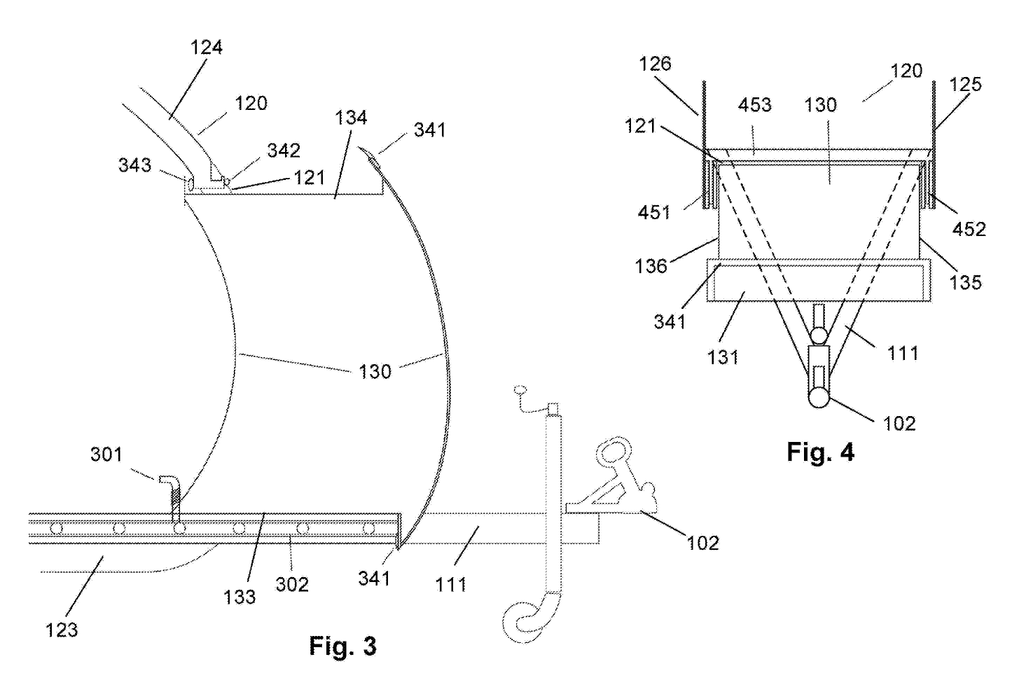

With regard to FIGS. 1 to 4, the caravan 100 includes a chassis 110 including wheels 101 and a drawbar 111 extending away from the wheels 101. The caravan 100 further includes a tow hitch 102 mounted at a terminal end of the drawbar 111. The caravan 100 also includes a hollow body 120 supported by the chassis 110. The body 120 defines an internal volume and includes an opening 121 (indicated in FIGS. 3 and 4) in a leading end of the body 120 facing the tow hitch 102.

The caravan 100 includes a slide-out extension 130 mounted in the opening 121. The slide-out extension 130 is slidingly moveable relative to the body 120 between a closed position (as shown in FIG. 1) in which the slide-out extension 130 is received within the body 120 and closes the opening 121, and an open position (as shown in FIGS. 2 to 4) in which the slide-out extension extends 130 from the opening 121 towards the tow hitch 102 to thereby expand the internal volume of the body 120. In particular, the slide-out extension 130 is at least partially supported by the drawbar 111 when in the open position.

It will be appreciated that the above described arrangement of the slide-out extension 130 of the caravan 100 allows expansion of the internal volume of the body 120 whilst avoiding the problems suffered by the cantilevered slide-outs used in conventional expandable caravans, since the drawbar 111 provides a stable support for the slide-out extension 130 when it is extended from the body 120. This can provide for relatively long extension distances compared to conventional expandable caravan slide-outs, with the length of the slide-out extension 130 mainly being limited by the available length of the drawbar 111 rather than cantilever strength of the interface between the slide-out extension 130 and the body 120.

Accordingly, a significant extension of the internal volume of the body 120 can be obtained, which can allow, for example, a useful extension of the available bed area in the caravan 100 when the slide-out extension 130 is in the open position without impinging on the space of other areas within the caravan, such as kitchen or wardrobe areas, or the like.

It is also noted that this configuration results in a substantial stability improvement compared to conventional expandable caravans, because any weight in the slide-out extension 130 will be distributed forward of the wheels 101 and at least partially onto either the tow hitch 102 when hitched to a towing vehicle or onto a jack 103 when the caravan is unhitched from a towing vehicle. This will help to avoid upping which can be a potential problem in some conventional expandable caravans with slide-outs where weight may be offset outwardly or rearwardly from the wheels.

It will be appreciated that caravans typically require an extended drawbar 111 between the caravan body and the tow hitch to allow maneuvering of the towing vehicle and caravan without interference between the leading end of the caravan body and the rear end of the towing vehicle during turns. This space above the drawbar is typically either under-utilized or not utilized at all in conventional caravan designs. Whilst some designs utilize some space above the drawbar for the storage of gas tanks, batteries or other equipment, the outside envelope of the potential storage space is restricted to avoid interference with the towing vehicle. In contrast, the slide-out extension 130 allows for a suitable length of drawbar 111 for avoiding interference between the body 120 and the towing vehicle when slide-out extension 130 is in the closed position for towing, but effectively utilizes the space above the drawbar 111 when the slide-out extension 130 is in the open position.

The caravan 100 may be made using conventional caravan construction techniques. Typically the chassis 110 and the drawbar 111 will be formed from a metal frame construction and the body 120 and slide-out extension 130 will be formed from a thin-walled construction using lightweight materials such as fiberglass.

In the depicted example, the caravan 100 is in the form of a teardrop camper, having a streamlined profile with a curved nose at a leading end of the body 120 and a tapered tail at a trailing end of the body 120 In this case, the slide-out extension 130 includes the curved nose section of the teardrop camper.

Since teardrop campers are generally designed to have a compact size to provide for light weight and easy towing, this tends to reduce the useful internal volume, placing severe limitations on the bed area and other internal features. However, with the slide-out extension 130, the teardrop camper can maintain a compact size when the slide-out extension 130 is in the closed position, but the internal volume can be significantly lengthened when the slide-out extension 130 is in the open position to allow new configurations of the bed area alongside kitchens areas, table areas, or other internal features that can not generally be provided in conventional teardrop campers.

Nevertheless, whilst the Figures depict the slide-out extension 130 in the context of a teardrop camper style of caravan, it will be appreciated that the slide-out extension 130 would also be readily applicable to other styles and shapes of towable caravans.

Preferred or optional features of embodiments the caravan 100 will now be described, again with reference to the example of FIGS. 1 to 8.

In preferred embodiments, when the slide-out extension 130 is in the open position, a portion of the slide-out extension 130 rests upon the drawbar 111 so that the slide-out extension 130 is at least partially supported by the drawbar 111. As shown in the top view of FIG. 4, the slide-out extension 130 extends over the drawbar 111 (shown in hidden detail beneath the slide-out, extension 130) so that the slide-out extension 130 can rest upon the drawbar 111 at any point along its length.

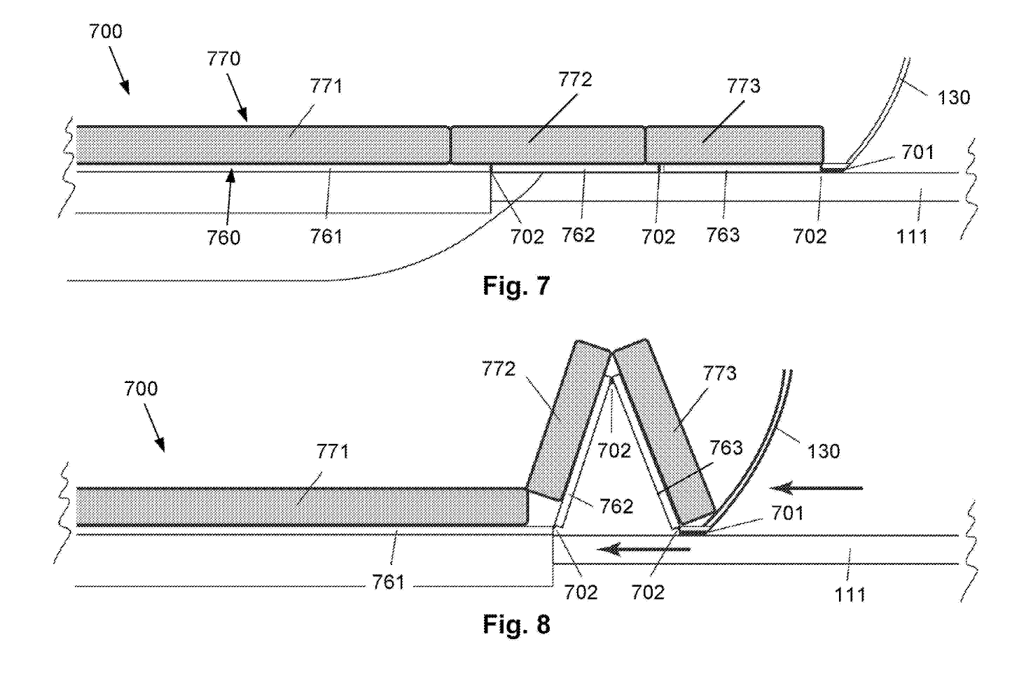

In some examples, the slide-out extension 130 is configured to slide along the drawbar 111 as the slide-out extension 130 is moved between the closed position and the open position. To facilitate this, the slide-out extension 130 may includes a skid pad 701 as shown in FIGS. 7 and 8, for allowing the slide-out extension 130 to slide along the drawbar 111 on the skid pad 701. The slide-out extension 130 will thus be at least partially supported by the drawbar 111 via the skid pad 701. One or more skid pads 701 may extend across a width of the slide-out extension 130 to ensure contact between at least a portion of a skid pad 701 and an upper surface of the drawbar 111, to account for tapering of the drawbar 111 towards the tow hitch 102 (as can be seen in FIG. 4). Preferably, the skid pads 701 will be formed from a low friction material such as polytetrafluoroethylene (commonly sold under the brand name TEFLON) or other suitable materials.

The slide-out extension 130 may be moved into the open position solely by sliding the slide-out extension 130 along the drawbar 111. However, as shown in FIG. 3, the slide-out extension 130 may further include slide, rails 302 mounted to the body 120 or the chassis 110. The slide-out extension 130 may thus be partially supported by the slide rails as the slide-out extension 130 is moved between the closed position and the open position.

Nevertheless, the drawbar 111 will still provide support for the slide-out extension 130, at least when the slide-out extension 130 is in the open position. Accordingly, the slide rails 302 do not need to be designed to withstand cantilevered loading of the slide-out extension 130. Rather, applied loads such as the weight of occupants lying on a bed in the slide-out extension 130 will be directly transferred to the drawbar 111. Despite this, the slide rails 302 can be used to assist in the smooth sliding action of the slide-out extension 130.

As shown in FIG. 3, the caravan 100 may include a locking pin 301 for locking the slide-out extension 130 relative to the body 120 to thereby prevent movement. For example, the locking pin 301 may be provided in association with the slide rails 301 to allow the slide rails 301 to be locked in predetermined positions to thereby lock the slide-out extension 130 to be locked in the closed position or the open position

As indicated in FIGS. 1 and 2, the body 120 may include a caravan tail 122 at a trailing end of the body 120 opposing the leading end, a caravan floor 123, a caravan roof 124 and opposing caravan side walls 125, 126. The slide-out extension 130 may include a slide-out nose 131, a slide-out floor 133, a slide-out roof 134 and opposing slide-out side walls 135, 136.

In preferred embodiments, the slide-out nose 131 closes the opening 121 when the slide-out extension 130 is in the dosed position, as shown in FIG. 1. Furthermore, when the slide-out extension 130 is in the closed position, the slide-out floor 133, roof 134 and side walls 135, 136 are preferably located inside of the caravan floor 123, roof 124 and side-walls 125, 126. The slide-out floor 133, roof 134 and side walls 135, 136 of the slide-out extension 130 are internally offset in relation to the caravan floor 123, roof 124 and side-walls 125, 126 of the body 120 as can be seen in FIGS. 3 and 4, and it will be understood that this allows the slide-out extension 130 to be received within the body 120.

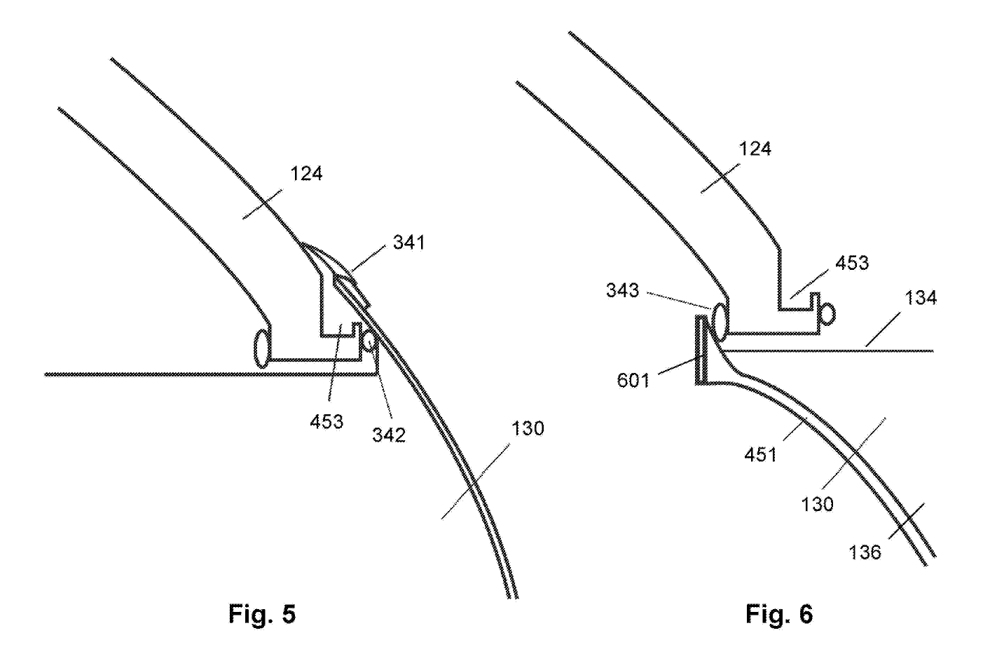

The slide-out nose 131 may include outer edges which overlap respective perimeter edges of the opening 121 when the slide-out extension 130 is in the closed position. This overlapping relationship can be generally observed from FIGS. 3 and 4, whilst FIG. 5 shows a detailed view of an upper outer edge of the slide-out nose 131 overlapping an upper perimeter edge of the opening 121 adjacent to the caravan roof 124. It will be appreciated that these overlapping edges can assist in the sealing of the opening 121.

The caravan 100 may include a series of sealing strips 341, 342, 343 provided around the slide-out nose 131 and the opening 121 to seal against water ingress in the closed and open positions of the slide-out extension 130.

The slide-out extension 130 may include a slide-out sealing strip 341 along at least one of the outer edges of the slide-out nose 131 for engaging with a respective perimeter edge of the opening 121 to form a seal when the slide-out extension 130 is in the closed position. In this example, the slide-out sealing strip 341 may be provided in the form of a flap of rubber or any other suitable resilient and water resistant material, which extends around the outside edges of the slide-out nose 131.

FIG. 5 shows details of the engagement between the slide-out sealing strip 341 along the upper outer edge of the slide-out nose 131 and the upper perimeter edge of the opening 121 adjacent to the caravan roof 124. The slide-out sealing strip 341 can thus provide a water tight seal around the opening 121 to prevent water ingress into the internal volume of the body 120, such as during transport or storage of the caravan 100 with the slide-out extension 130 is in the closed position.

The body may also include an outer body sealing strip 342 along an outside surface of at least one perimeter edge of the opening 121, for engaging with an inside surface of the slide-out nose 131 to form a seal when the slide-out extension 130 is in the closed position. FIG. 5 also shows the engagement between the outer body sealing strip 342 and the inside surface near an upper edge of the slide-out nose 131. Although the slide-out sealing strip 341 alone may provide a sufficient seal, the outer body sealing strip :42 can provide a secondary seal insuring against the ingress of water that may make it past the slide-out sealing strip 341.

Furthermore, the body 120 may include an inner body sealing strip 343 along an inside surface of at least one perimeter edge of the opening 121. The inner body sealing strip 343 for engaging with a ridge 601 along a trailing edge of at least one of the slide-out floor 133, roof 134 and side walls 135, 136 to form a seal when the slide-out extension 130 is in the open position. FIG. 6 shows an example of the engagement between the inner body sealing strip 343 and the ridge 601. Thus, the inner body sealing strip 343 can prevent water ingress into the internal volume of the body 120 when the caravan 100 is in use with the slide-out extension 130 is in the open position.

The caravan 100 may also include water drainage provisions for preventing water from collecting on surfaces of the caravan 100, and thus further helping to prevent water ingress into the internal volume of the body 120. Examples of these water drainage provisions can be seen in FIG. 4 and the detailed views of FIGS. 5 and 6.

For instance, the body 120 may include a gutter 453 extending along an upper perimeter edge of the opening 121 adjacent to the caravan roof 124. Rainwater falling on the caravan roof 124 can flow into the gutter 453 and be directed away from the slide-out roof 134 instead of flowing onto the slide-out roof 134.

As shown in FIG. 4, the body 120 may also include drains 451, 452 extending along side perimeter edges of the opening 121 adjacent to the caravan side walls 125, 126. The drains 451, 452 may be connected to ends of the gutter 453 so that water flowing into the gutters can be directed into the drains 451, 452. Water flowing through the drains 451, 452 can fall to the ground without a chance to collect on surfaces of the slide-out extension 130.

The slide-out roof 134 will preferably have a convex upper surface, to ensure that any water that lands on the slide-out roof 134 will flow to the sides of the slide-out extension rather than collecting on the slide-out roof 134.

Preferred embodiments of the caravan 100 may also include a folding bed that is reconfigurable between a folded configuration when the slide-out extension 130 is in the closed position and a flat configuration when the slide-out extension 130 is in the open position.

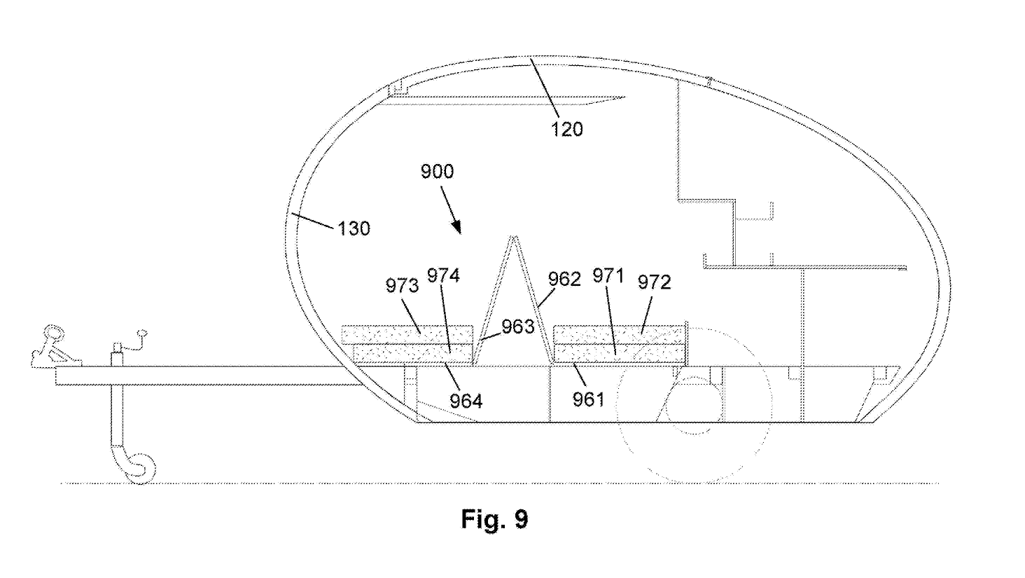

An example of a first embodiment of such a folding bed 700 is shown in FIGS. 7 and 8. Further examples depicting alternative embodiments of the folding bed will be described in due course with respect to FIGS. 9 to 15.

With regard to the example of FIGS. 7 and 8, the folding bed 700 may include a plurality of panels 761, 762, 763 for supporting mattress sections 771, 772, 773 The mattress sections 771, 772, 773 will typically be provided separately from the panels 761, 762, 763 to accommodate the different configurations of the folding bed 700. At least one of the panels 761, 762, 763 is hinged for allowing at least a portion of the folding bed to be folded inside the internal volume of the body 120 when the slide-out extension 130 is in the dosed position.

As shown in FIG. 7, when the slide-out extension 130 is in the open position and the folding bed 700 is in the flat configuration, the panels 761, 762, 763 provide a flat floor 760. The mattress sections 771, 772, 773 are arranged on the panels 761, 762, 763 providing the floor 760 to provide a flat mattress 770 of the folding bed 700.

Preferably, at least one of the panels 761, 762, 763 provides a floor portion of the slide-out extension 130 when the slide-out extension 130 is in the open position. In the example of FIG. 7, this floor portion is provided by two end panels 762, 763 which are connected to the slide-out extension 130 by a hinge 702 As shown in FIG. 8, these two end panels 762, 763 are hingedly connected together and to another panel 761 on the caravan floor 123 by additional hinges 702 and configured to fold together in a raised arrangement when the slide-out extension 130 moves towards the closed position as indicated by the arrows, such that the folding bed 700 moves into the folded configuration.

In alternative embodiments, the folding bed may be further reconfigurable from the flat configuration into a lounge configuration when the slide-out, extension 130 is in the open position. To illustrate this feature, an example of a second embodiment of a folding bed 900 for use with the caravan 100 and slide-out extension 130 will now be described with reference to FIGS. 9 to 11.

In this example, the folding bed 900 includes a plurality of hingedly connected panels 961, 962, 963, 964 and generally corresponding mattress sections 971, 972, 973, 974 which can be moved separately and positioned depending on the configuration of the folding bed 900. FIG. 9 shows the folding bed 900 in the folded configuration, in which an intermediate pair of panels 962, 963 fold together in a raised arrangement, and respective mattress sections 972, 973 have been stacked on other mattress sections 971, 974.

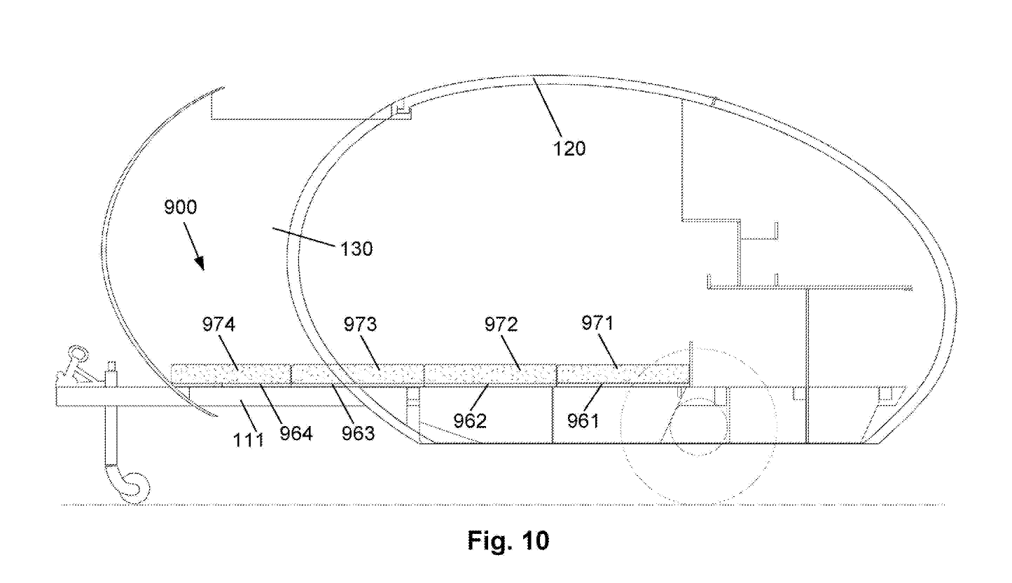

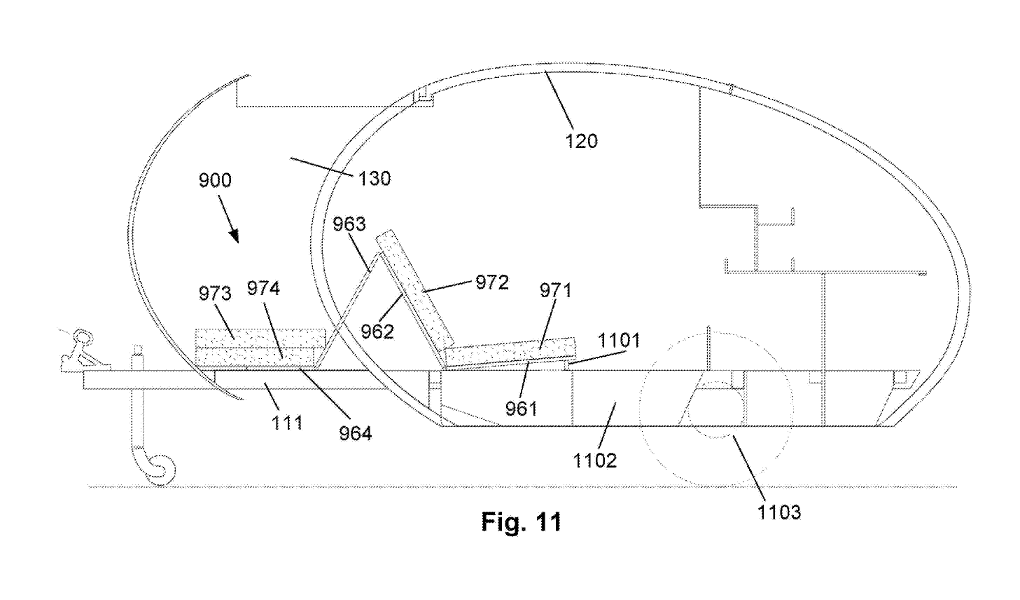

The hingedly connected panels 961, 962, 963, 964 of the folding bed 900 includes an end panel 961 that is moveable between a first position for providing an end of the folding bed 700 in the flat configuration as shown in FIG. 10, and a second position for providing a lounge seat in the lounge configuration as shown in FIG. 11. When the end panel 961 is in the second position, a supporting bar 1101 may be used to slightly tilt the end panel 961 into a more comfortable lounge seat position. The intermediate pair of panels 962, 963 is configured to fold together in a raised arrangement for providing a lounge back as also shown in FIG. 11.

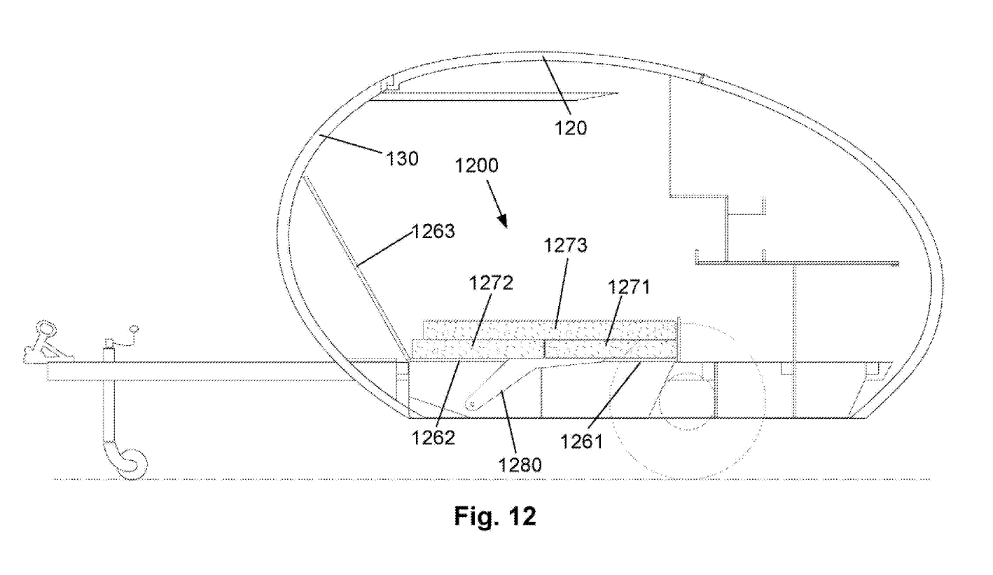

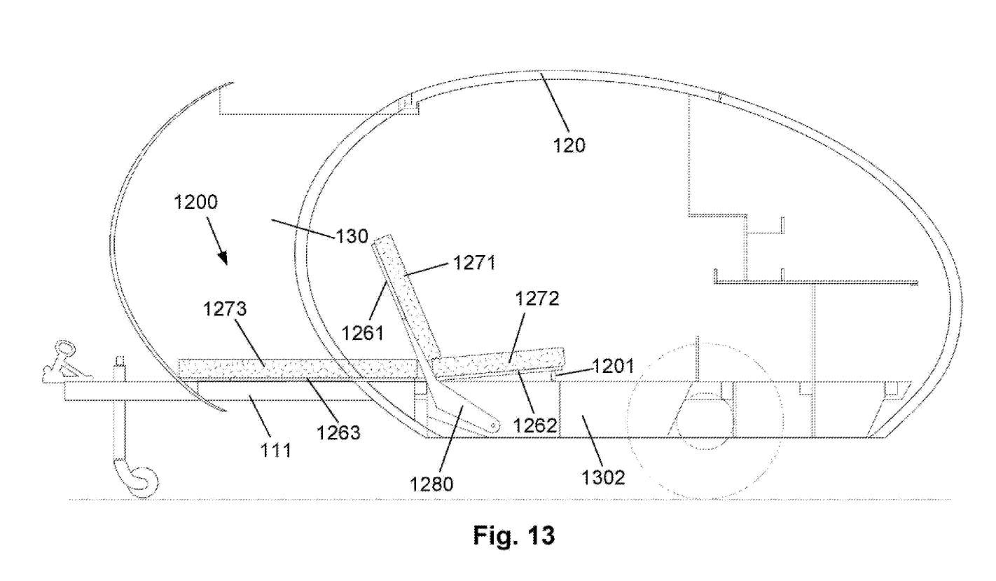

An example of a third embodiment of the folding bed 1200 for use with the caravan 100 and slide-out extension 130 will now be described with reference to FIGS. 12 and 13.

In this case, the folding bed 1200 includes three panels 1261, 1262, 1263 and corresponding mattress portions 1271, 1272, 1273. A larger one of the mattress portions 1273 is stacked upon the smaller two mattress portions 1271, 1272 when the folding bed 1200 is in the folded position.

The panels 1261, 1262, 1263 include an end panel 1261 mounted on brackets 1280 that are pivoted relative to the body 120 so that the end panel 1261 is moveable between a first position for providing an end of the folding bed 1200 in the flat configuration (not shown, but with positioning as per the folded configuration of FIG. 12) and a second position for providing a lounge back in the lounge configuration as shown in FIG. 13.

An intermediate panel 1262 provides a lounge seat in the lounge configuration. As per the previous example, a supporting bar 1101 may be used to slightly tilt the end panel 961 into a more comfortable lounge seat position. A folding panel 1263 is hingedly connected to the intermediate panel 1262. The folding panel 1263 folds upwardly when the slide-out extension 130 is closed as in FIG. 12 and lays flat inside the slide-out extension 130 when the slide-out extension 130 is opened as in FIG. 13, irrespective of whether the folding bed 1200 is in the flat configuration or in the lounge configuration.

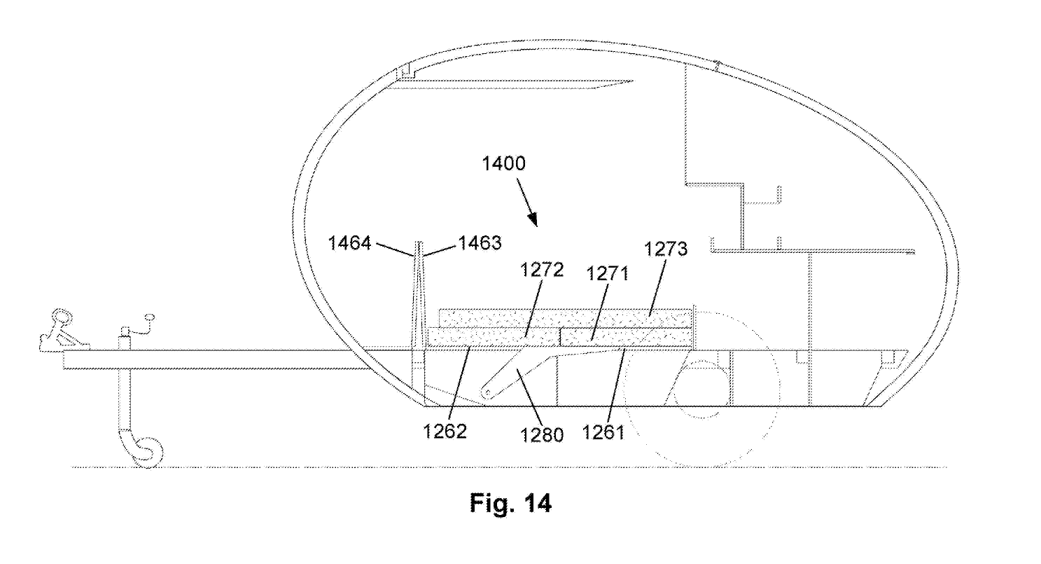

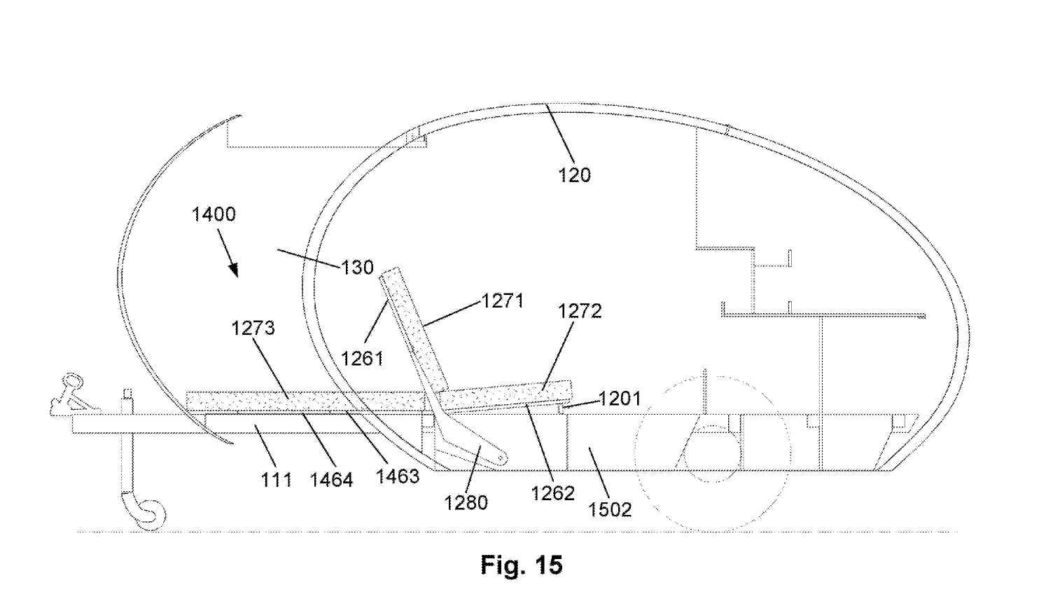

An example of a fourth embodiment of the folding bed 1400 for use with the caravan 100 and slide-out extension 130 will now be described with reference to FIGS. 14 and 15.

This embodiment of the folding bed 1400 is generally similar to the previous embodiment of the folding bed 1200, but instead of having a single folding panel 1263 as discussed above, the folding bed 1400 includes a pair of folding panels 1463, 1464 which fold together in a raised arrangement when the slide-out extension 130 is closed as in FIG. 14 and lay flat inside the slide-out extension 130 when the slide-out extension 130 is opened as in FIG. 15. Otherwise, the functionality of the remaining panels 1261, 1262 is as per the previous example.

In any of the embodiments of the folding lounges 900, 1200, 1400 that are capable of being reconfigured into a lounge configuration, moving the end panel 961, 1261 away from the flat first position exposes a recessed floor area 1102, 4302, 1502 for receiving feet of a user of the folding bed 900, 1200, 1400 in the lounge configuration, as shown in FIGS. 11. 13 and 15, respectively. This can allow a user to comfortably sit in the caravan. An extendable table may be provided for allowing a portion of the table to be conveniently extended into a suitable position for eating, without needing to permanently intrude into the internal volume of the body 120.

Further details of the preferred embodiment of the caravan 100 and the slide-out extension 130 arrangement will now be described, with reference to FIGS. 1 to 8

This embodiment relates to a teardrop camper. More particularly, this embodiment relates to the slide out extension of the complete front of the teardrop camper and an automatic fold-away bed.

The preferred embodiment provides a complete slide-out the full width of the teardrop camper. The slide-out operates smoothly on two extension slides and the base of the slide-out has a TEFLON base that slides easily on the drawbar. This enables increased space for storage in both the kitchen and wardrobe area. When the slide-out extends it automatically unfolds the floor and mattress that closes down onto the drawbar. The strength of the floor relies on the drawbar of the sub-frame underneath to support the occupants when in the sleeping position. The use of the drawbar as support for the slide-out and floor system enables great weight saving which is important for the fuel economy and the ability of small cars to tow this teardrop camper. A combination of seals and gutters allow for watertight operation in both the closed and open positions.

To assist with the understanding of the preferred embodiment, reference will now be made to the accompanying drawings showing examples of the embodiment and its components.

in the drawings, FIG. 1 shows the teardrop camper in the closed and travelling position. FIG. 2 shows the teardrop camper in the open position or setup for camping. FIG. 3 shows a cross section of the teardrop camper's slide-out. FIG. 4 is an aerial perspective of the slide-out. FIG. 5 shows a cross section of the seal in the closed position. FIG. 6 shows a cross section of the seal in the open position, FIG. 7 shows a cross section of the fold out bedding and base extended. FIG. 8 shows a cross section of the fold out bedding and base closing.

Referring to FIG. 1, the teardrop camper is in the closed position with the slide-out section fully enclosed and locked in the towing position.

Referring to FIG. 2, the teardrop camper is in the fully open position ready for camping. The slide-out section slides on the drawbar with the aid of TEFLON skid pads and extension slides mounted to the body or chassis. The shape of the nose section aids with the sealing, even though the internal locks keep the nose section locked when driving the wind force closes the nose section even tighter onto the seals. The slide-out consists of the front, two sides and the roof all constructed as one piece.

Referring to FIG. 3, this shows a cross section side view of the slide-out 130 fully extended out of the body 120. The slide-out can be slid in and out of the body by first releasing the locking pin 301 and extending or closing the slide-out on the sliding rails 302 that are mounted on the subframe or body and the TEFLON skid plates mounted underneath the slide-out that slide on the drawbar 111 of the subframe. The slide-out can be extended or closed manually or motorised. When in the fully open or fully closed position, a series of rubber seals 341, 342, 343 to prevent against the elements, are located on all four edges of the slide-out 130 and the body 120.

Referring to FIG. 4, this is an aerial perspective of the slide-out 130 extended out of the body 120 and how the slide-out 130 is almost the complete width of the body 120. For the purpose of the diagram to show the detail, the dimensions of the side drains 451, 452 have been enlarged and not true to scale but the width of these can be as little as 15 mm. This perspective also shows how any ram water drains from the roof of the teardrop calliper body 120 into the gutter 453 and then down the side drains 451, 452. Any rain water that falls on the slide-out 130 is sealed from entering into the cabin area by a series of seals shown in other diagrams.

Referring to FIG. 5, this shows after the action of closing the slide-out 130 against the body 120 and how the flap rubber seal 341 closes against the body 120 to seal against the elements. There is a second barrier rubber seal 342 that is mounted on the top and both sides of the body 120 as insurance against penetration of any moisture or dust past the first seal 341 when in the closed position. If any water penetrates the rubber seal 341, it catches in the drain gutter 453 and is directed away with the drains 451, 452 either side of the body as shown in FIG. 4.

Referring to FIG. 6, this shows after the action of opening the slide-out 130 how the back ridge and drain 451 closes against the rubber seal 343 that continues around the top and both sides of the body 120 In the event of inclement weather all excess water runs down the body 120 into the drain gutter 453 and is directed away with the drains 451, 452 either side of the body as shown in FIG. 4.

Referring to FIGS. 7 and 8, these show the bed mattress 760 and bed base 770 and how it automatically folds out flat when the slide-out 130 is extended and folds up when closed. The slide-out is extended with the support of the subframe's drawbar 120 with the Teflon skid-plate 780 mounted underneath the slide-out 130 to enable smooth operation. The slide-out 130 is also mounted by sliding rails which also aid this operation but not in this diagram. The bed base 770 is in sections 771, 772, 773 with hinges 780 on each edge joining all the sections with the bed mattress in three sections 761, 762, 763 to correspond with all movements of the bed base 770 underneath it.

The use of the slide-out in the teardrop camper will provide a much larger internal space in a smaller and lighter teardrop camper making it easier to tow, park and store whilst having the internal dimensions when extended, of a teardrop camper almost twice the external dimensions. With the slide-out extension of the teardrop camper this increases the internal space for the bedroom and increases the storage area.

In view of the above, the preferred embodiment of FIGS. 1 to 8 provides a lightweight slide-out compartment that is mounted in the teardrop camper with an automatic internal fold out floor and mattress using the subframe's drawbar and sliding runners to support it whilst sliding smoothly on TEFLON runners in the motion of opening and closing to allow the internal space of the teardrop camper to almost double.

Further details of embodiments of folding bed configurations for use with the slide-out extension 130 will now be described, with reference to FIGS. 9 to 15.

These embodiments relate to a folding bed/lounge for a slide-out extension within a teardrop camper. More particularly, these embodiments relate to the folding floor and with different configurations converting from a bed to a lounge.

These embodiments use the sections of the floor in different configurations to provide a bed base that then converts to a lounge in seconds. The floor is in the folded position for travelling, flattened out for use as a bed and folded in a different configuration to become a lounge all while the mattress sections of the bed fit perfectly as the lounge seating.

To assist with the understanding of these preferred embodiments, reference will now be made to the accompanying drawings showing examples of the preferred embodiments and their components.

In the drawings, FIG. 9 shows the teardrop camper in the closed and travelling position. FIG. 10 shows the teardrop camper in the open position with the floor in the bed position FIG. 11 shows the teardrop camper in the open position with the floor folded up to a lounge. FIG. 12 shows the teardrop camper in the closed and traveling position but a different configuration. FIG. 13 shows the teardrop camper in the open position but with a different configuration for the lounge. FIG. 14 shows the teardrop camper in the closed and travelling position but with another configuration. FIG. 15 shows the teardrop camper in the open position with another configuration.

Referring to FIG. 9, the teardrop camper is in the closed position with the slide-out section fully enclosed and locked in the towing position. The floor sections 961, 962, 963, 964 are in the folded position for travelling with the slide-out section 130 fully enclosed into the body 120 and locked into position. The mattress sections 971, 972, 973, 974 are laid flat for transport.

Referring to FIG. 10, the teardrop camper is in the fully open position ready for camping. The slide-out section 130 slides out of the main body 120 sliding on the drawbar 111 with the aid of TEFLON skid pads and extension slides mounted to the body 120 or chassis. The floor sections 961, 962, 963, 964 of the bedding area open automatically into position and are supported by the drawbar 111. The sections of the floor 961, 962, 963, 964 are hinged together so in the fully extended position it also locks the teardrop camper in the fully open position although it can also be locked by locking pins or similar product. The mattress sections 971, 972, 973, 974 are then laid out over the floor area to form the bed

Referring to FIG. 11, this shows the same view as FIG. 10 but with the hinged floor sections 961, 962, 963, 964 pushed up into the seating position. That is, by lifting the first section of the floor 961 and lifting it back into the seating position, locking it in position with the supporting bar 1101 This exposes the recessed floor area 1102 where the occupants place their feet whilst in the seated position. All this is supported on the drawbar 111 section of the subframe that runs the length from the trailer hitch 101 to a position parallel with the axle assembly area 6. Now the mattress sections 971, 972, 973, 974 can be put in position to form the lounge.

Referring to FIG. 12, this shows the teardrop camper in the closed position but with a different flooring and lounge configuration. In this version the floor sections 1261, 1262, 1263 are in three separate sections all moving independently In the travelling position two of these sections 1261, 1262 are in the horizontal flooring position and the third section 1263 is held in the raised position shown.

Referring to FIG. 13, this shows the teardrop camper as in FIG. 12 but in the open position. In this example the slide-out section 130 is in tire fully extended position having been extended out of the teardrop camper's body 120. The floor section 1263 has been lowered into position and is supported on the drawbar 111. The floor section 1261 is swung back into position on the brackets 1280 to become the backrest of the lounge. This action reveals the recessed floor area 1202 that becomes the footrest space for the occupants. The final floor section 1262 is lifted at the front and rested on the support bar 1201. Now the mattress sections 1271 1272, 1273 can be put in position to form the lounge.

Referring to FIG. 14, this shows the same closed and travelling position as in FIG. 12 but the difference is the forward floor sections 1463, 1464 fold together so it remains fixed to the slide-out whilst in the travelling position.

Referring to FIG. 15, this shows how the floor sections 1463, 1464 fold down onto the drawbar 111 once the slide-out 130 is pulled out fully from the body 120. The floor section 1261 is swung back into position on the brackets 1280 to become the backrest of the lounge. This action reveals the recessed floor area 1202 that becomes the footrest space for the occupants. The final floor section 1262 is lifted at the front and rested on the support bar 1201. Now the mattress sections 1271, 1272, 1273 can be put in position to form the lounge.

The use of the floor sections in different configurations in the bed area of the teardrop camper enable it to be a multi use area instead of just a bed, as it can now be converted to a lounge and with the use of a small folding table, dining or even a small office whilst on the road travelling.

In view of the above, the embodiments of FIGS. 9 to 15 provide several sections of flooring, hinges and brackets not fixed to the steel section floor frame but floating, which can be positioned in such a way as to when the slide-out teardrop is extended it becomes a lounge using the mattress sections as the cushioning but can be easily un-folded flat again to become a bed or when transporting folds up into a fixed position.

Throughout this specification and claims which follow, unless the context requires otherwise, the word “comprise”, and variations such as “comprises” or “comprising”, be understood to imply the inclusion of a stated integer or group of integers or steps but not the exclusion of any other integer or group of integers.

1) A caravan including:
a) a chassis including wheels and a drawbar extending away from the wheels;
b) a tow hitch mounted at a terminal end of the drawbar;
c) a hollow body supported by the chassis, the body defining an internal volume and including an opening in a leading end of the body facing the tow hitch; and,
d) a slide-out extension mounted in the opening, the slide-out extension being slidingly moveable relative to the body between a closed position in which the slide-out extension is received within the body and closes the opening, and an open position in which the slide-out extension extends from the opening towards the tow hitch to thereby expand the internal volume of the body, the slide-out extension being at least partially supported by the drawbar when in the open position.

2) A caravan according to claim 1, wherein, when the slide-out extension is in the open position, a portion of the slide-out extension rests upon the drawbar so that the slide-out extension is least partially supported by the drawbar.

3) A caravan according to claim 2, wherein the slide-out extension is configured to slide along the drawbar as the slide-out extension is moved between the closed position and the open position.

4) A caravan according to claim 3, wherein the slide-out extension includes skid pads for allowing the slide-out extension to slide along the drawbar on the skid pads, the slide-out extension being at least partially supported by the drawbar via the skid pads.

5) A caravan according to claim 1, wherein the slide-out extension further includes slide rails mounted to one of the body and the chassis, the slide-out extension being partially supported by the slide rails as the slide-out extension is moved between the closed position and the open position.

6) A caravan according to any one of claim 1, wherein the body includes a caravan tail at a trailing end of the body opposing the leading end, a caravan floor, a caravan roof and opposing caravan side walls, and the slide-out extension includes a slide-out nose, a slide-out floor, a slide-out roof and opposing slide-out side walls, wherein the slide-out nose closes the opening when the slide-out extension is in the closed position.

7) A caravan according to claim 6, wherein, when the slide-out extension is in the closed position, the slide-out roof, floor and side walls are located inside of the caravan roof, floor and side-walls.

8) A caravan according to claim 6, wherein the slide-out nose includes outer edges which overlap respective perimeter edges of the opening when the slide-out extension is in the closed position and the slide-out extension includes a slide-out sealing strip along at least one of the outer edges of the slide-out nose for engaging with a respective perimeter edge of the opening to form a seal when the slide-out extension is in the closed position.

9) (canceled)

10) A caravan according to any one of claim 6, wherein the body includes at least one of:
a. an outer body sealing strip along an outside surface of at least one perimeter edge of the opening for engaging with an inside surface of the slide-out nose to form a seal when the slide-out extension is in the closed position; and
b. an inner body sealing strip along an inside surface of at least one perimeter edge of the opening for engaging with a ridge along a trailing edge of at least one of the slide-out floor, roof and side walls to form a seal when the slide-out extension is in the open position.

11) (canceled)

12) A caravan according to claim 6, wherein at least one of:
a. the body includes a gutter extending along an upper perimeter edge of the opening adjacent to the caravan roof;
b. the body includes drains extending alongside perimeter edges of the opening adjacent to the caravan side walls; and
c. the slide-out roof includes a convex upper surface.

13) (canceled)

14) (canceled)

15) A caravan according to claim 1, wherein the caravan includes a locking pin for locking the slide-out extension relative to the body to thereby prevent movement.

16) A caravan according to claim 1, wherein the caravan includes a folding bed that is reconfigurable between a folded configuration when the slide-out extension is in the closed position and a flat configuration when the slide-out extension is in the open position.

17) A caravan according to claim 16, wherein the folding bed includes a plurality of panels for supporting mattress sections, at least one of the panels being hinged for allowing at least a portion of the folding bed to be folded inside the internal volume of the body when the slide-out extension is in the closed position.

18) A caravan according to claim 17, wherein at least one of the panels provides a floor portion of the slide-out extension when the slide-out extension is in the open position.

19) A caravan according to claim 17, wherein the folding bed includes two hingedly connected panels that fold together in a raised arrangement when the slide-out extension is in the closed position and the folding bed is in the folded configuration.

20) A caravan according to claim 15, wherein the folding bed is further reconfigurable from the flat configuration into a lounge configuration when the slide-out extension is in the open position. 21) (Currently amended) A caravan according to claim 20, wherein the folding bed includes at least one of:
a. a plurality of hingedly connected panels including an end panel that is moveable between a first position for providing an end of the folding bed in the flat configuration and a second position for providing a lounge seat in the lounge configuration, at least two other panels folding together in a raised arrangement for providing a lounge back; and
b. an end panel mounted on brackets that are pivoted relative to the body so that the end panel that is moveable between a first position for providing an end of the folding bed in the flat configuration and a second position for providing a lounge back in the lounge configuration.

22) (canceled)

23) A caravan according to claim 21, wherein moving the end panel away from the first position exposes a recessed floor area for receiving feet of a user of the folding bed in the lounge configuration.

24) A caravan according to claim 1, wherein the caravan is in the form of a teardrop camper.

25) A caravan according to claim 24, wherein the slide-out extension includes a curved nose section of the teardrop camper.

26) (canceled)

27) (canceled)
